(19) United States
(12) Patent Application Publication
(10) Pub. No.: US 2009/0154361 A1
(43) Pub. Date: Jun. 18, 2009

(54) METHOD AND SYSTEM FOR USING PROTOCOL CHECKSUMS TO CONVEY DATA

(75) Inventor: John A. DUNNING, Nepean (CA)

Correspondence Address: CHRISTOPHER & WEISBERG, P.A., 200 EAST LAS OLAS BOULEVARD, SUITE 2040, FORT LAUDERDALE, FL, 33301, US

(73) Assignee: NORTEL NETWORKS LIMITED, Saint-Laurent (CA)

(21) Appl. No.: 11/955,950

(22) Filed: Dec. 13, 2007

(51) Int. Cl. H04L 1/00

(52) U.S. Cl. 370/241

(57) ABSTRACT

The present invention provides a system and method for transmitting data, including transmitting a first data packet having at least one checksum value across a network, generating a second data packet substantially similar to the first data packet, the second data packet having a checksum value, modifying the checksum value of the second data packet, transmitting the second data packet with the modified checksum value across the network, and assessing a network performance metric based at least in part upon the modified checksum value.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to computer networks and data communication, and more specifically, to a method and apparatus for using protocol checksums to convey data.

### BACKGROUND OF THE INVENTION

As communication network use and the Internet began to develop, methods for determining information about the performance, distance, or path information between network components have become integral in network architecture and administration. For example, the measurement of the time it takes to send and receive a packet of data became one widely used performance metric. This measurement is commonly called the round trip time (“RTT”) and can be gathered through the use of various protocols as well by measuring the amount of time taken to send and receive the packet. Data packets typically include message data and various header information. Header information may include several information fields, such as the source port, destination port, a checksum field, and others, for example. In particular, data packets often include a field in the packet header to provide information as to the number of servers or routers a packet traversed in its path between the source and destination of the packet. The field that identifies the particular hop count is known as the time to live (“TTL”) field.

Internet Control Message Protocol (“ICMP”), Transmission Control Protocol (“TCP”), and User Datagram Protocol (“UDP”) are all transport layer protocols that are then encapsulated in internet protocol (“IP”) data packets to be sent across an IP network such as the Internet. The UDP is an internet transport protocol that supports best effort delivery of packets (that is, no retransmission of corrupt or lost packets is performed). The TCP is the primary virtual-circuit transport protocol for the Internet suite. TCP provides reliable, in-sequence delivery of a full-duplex stream of octets (8-bit bytes), and is commonly used by those application programs needing reliable, connection-oriented transport services. The TCP provides data flow control to and from network applications, detects and recovers lost or corrupted message packets; and guarantees reliable transmission. The IP allows data packets to be sent and received across networks. When messages are sent from one computing device to another, the message data is passed through various modules, including the TCP and IP modules.

All of these protocols can be used to gather measurements like the RTT and the TTL of a particular transmitted packet. The TTL can be used to determine the path a packet takes from one computer system to another computer system mapping out all of the nodes between the two hosts by sending out packets starting with a TTL of 1 to get the IP address or name of the first hop from the sender to the recipient of the packet, the second packet sent out can include a TTL field set to 2 in order to obtain the name or IP address of the host at the second hop in the path between the source or sending client and the destination or recipient client, etc. The TTL field can be continually incremented until the final destination is reached. The round trip time of each step in the iterative process can also be returned to help gather the path information and the performance metrics for each hop, server, or router along the path between the two hosts.

While the above mentioned protocols provide desirable information regarding the performance, distance, or path information between network components, the actual measurements or performance indication obtained from transmission of a measuring or performance metric packet may differ from an actual network performance or measurement with respect to a data or payload packet. Typically a measurement or performance metric packet has content or characteristics that substantively differ from a normal message or payload packet. As a message or data payload packet differs from a measurement or performance metric packet in size, content, etc., there is a chance that the network components will treat the packets differently, i.e., use a different network path, have different associated delays, etc. As such, the performance indications or path information obtained through the use of a measurement packet do not necessarily correlate to or otherwise indicate the network environment and associated performance or handling circumstances (e.g., RTT, TTL, etc.) affecting an actual message/payload packet. Presently, there is no effective method that substantially duplicates a message or payload packet for network performance measurement purposes, and thus there is an ever-present chance that a measured characteristic using a measurement packet does not accurately reflect the performance or handling of a payload or message packet.

Accordingly, it is desirable to provide for the measurement of one or more network performance criterion that closely approximates or duplicates the actual handling and/or performance related to a message payload packet.

### SUMMARY OF THE INVENTION

The present invention advantageously provides a method for transmitting a data packet having a checksum field across a network, including appending a checksum value that does not correspond to the content of the data packet to the checksum field, and transmitting the data packet. The method may include appending the checksum value by replacing a checksum value corresponding to the content of the data packet with different data or adding additional data to a checksum value corresponding to the content of the data packet. The data packet may include one or more protocol headers, and the checksum field may be in a transmission control protocol header of the data packet. The method may also include encrypting the second checksum value; receiving the data packet; and extracting the second checksum value from the data packet.

The present invention also provides a method for assessing network performance, including transmitting a first data packet having a first data in a checksum field across a network; generating a second data packet, the second data packet being substantially similar to the first data packet, the second data packet having the first data in the checksum field; changing the first data to a second data in the checksum field; transmitting the second data packet with the second data across the network; and assessing a network performance metric based at least in part upon the second data.

A system for transmitting data packets across a network is also provided, including a sending entity encapsulating a data packet having at first checksum value in a checksum field, the sending entity modifying the first checksum value to a second checksum value and transmitting the data packet across the network. The first checksum value may correspond to content of the data packet, while the second checksum value may not correspond to the content of the data packet. The system may further include a recipient receiving the data packet and extracting the second checksum value, where the recipient assesses a network performance metric based at least upon the second checksum value, such as a trip time or a network path.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a data communication system constructed in accordance with the principles of the present invention;

FIG. 2 is an illustration of an embodiment of a data message in accordance with the present invention; and

FIG. 3 is a flow chart of an exemplary method of transmitting data in accordance with the principles of the present invention.

### DETAILED DESCRIPTION OF THE INVENTION

The present invention provides a system and method of use thereof for the measurement of one or more network performance criterion that closely approximates or duplicates the actual handling and/or performance related to a message payload packet. In particular, the present invention provides a system and method of using protocol checksums to convey data that otherwise leaves a data packet unchanged for subsequent transmission.

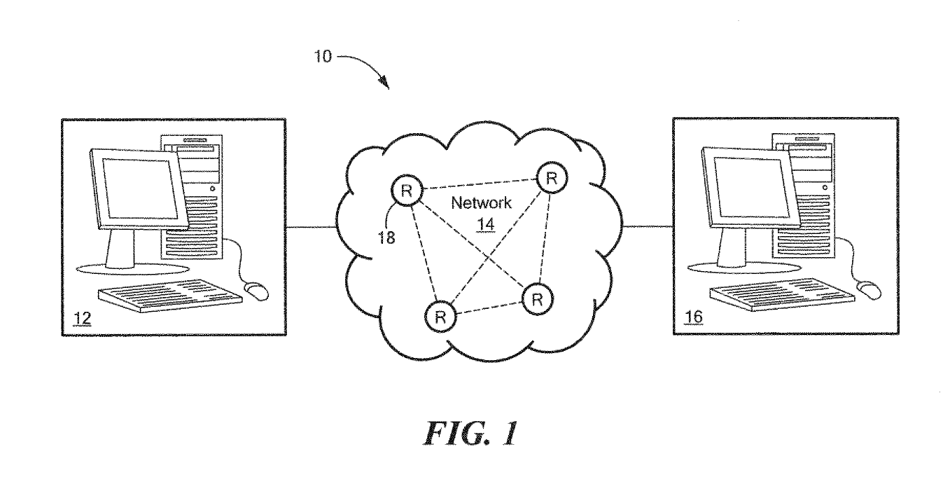

Referring now to the drawing figures in which like reference designators refer to like elements, there is shown in FIG. 1, a data communication system constructed in accordance with the principles of the present invention and designated generally as “10”. The system 10 generally includes a sending entity 12 coupled to a communication network 14 for sending one or more data messages to a recipient 16. Both the sending entity 12 and the recipient 16 can include computing hardware components, software components, or a combination of hardware and software. For example, the sending entity 12 and the recipient 16 may include devices having a processor, memory storage components, communication hardware, as well as software for encapsulating, interpreting or otherwise extracting information of data messages, and may include but are not limited to computers, mobile phones, wireless devices, PDAs, or the like. The communication network 14 may include a wired or wireless network having one or more routers, nodes, or other networking components 18 providing one or more data communication paths between the sending entity 12 and the recipient 16. Further, the communication network 14 may include the capacity for SMS messaging, telephone, wireless communication, paging, instant messaging or the like and may operate with various communication protocols, such as TCP/IP or the like as described above.

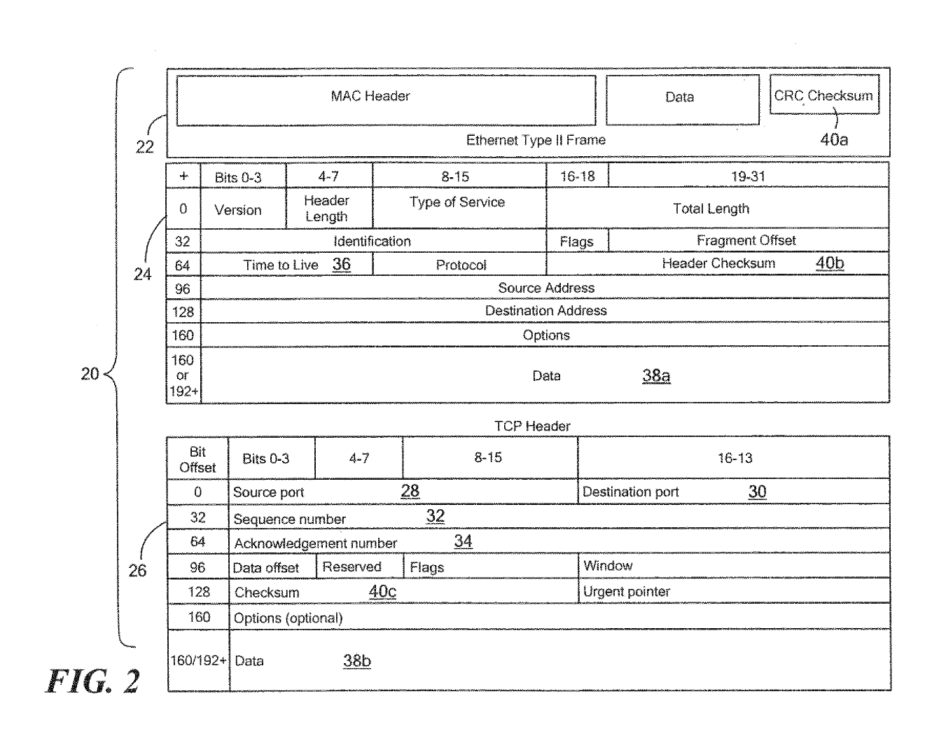

In data communication systems, data is often encapsulated into data messages or packets and transmitted among various entities of the system. The sending entity, for example, may formulate one or more data messages and transmit them across the network for receipt by the recipient. The recipient captures the data messages and retrieves and/or otherwise processes the data. Now referring to FIG. 2, a block diagram of a network data message 20 having an Ethernet layer and associated header 22, an IP layer and associated header 24, and a TCP layer and associated header 26 is shown. Of course, while an Ethernet type II frame is shown, the system and methods described herein are not limited to this particular illustration, as they are equally applicable with numerous communication applications, protocols and systems employing a checksum or error-detection scheme. The message 20 includes a plurality of fields having information therein with respect to various features or characteristics of the message and its protocol layers. For example, the message may include a source port field 28, a destination port field 30, a sequence number (“SEQ. NO.”) field 32, an acknowledgment number (“ACK. NO.”) field 34, a time to live field 36, data fields 38a, 38b, etc.

Each of the Ethernet, IP and TCP layers may further include checksum fields 40a, 40b, and 40c, respectively. During data transmission, errors can be introduced into the data and accordingly, error control has become an integral part of computer network systems. One of the primary methods to control data transmission errors is known as error detection, and a typical error-detection technique includes calculation of a checksum value appended to each data message. For checksum error detection, typically an agreed-upon algorithm (e.g., a parity check, cyclic redundancy check, hashing function, summation of the number of bits in the packet equal to 1, summation of the numerical values represented by the data, etc.) is applied to the contents of the message prior to its transmission so as to generate a corresponding checksum. The generated checksum is then appended to the data message by the sending entity and the message is transmitted across the network. Upon receipt of the message, the receiving entity applies the same, agreed-upon algorithm to the contents of the message and determines whether its calculation of the checksum matches the checksum contained in the message. If so, the receiving entity concludes that no errors were introduced into the message during its transmission and, therefore, continues processing the data. If the two values do not match, the receiving entity assumes that errors are present in the data and the message is typically discarded.

A checksum value may be included for each of the layers or protocols of a particular message. For example, to calculate the checksum value pursuant to the TCP protocol, the TCP checksum field 40c is initially set to zero and the data field 38b may be padded with an additional zero byte if its length is an odd number. Next, the sending entity 12 adds up all of the 16-bit portions of the message 20 in 1's complement and then the 1's complement of the sum is taken. In other words, all of the 16-bit portions of the message 20 are summed and the carry over values are added back into the sum. The 16-bit result is loaded into the checksum field and the message 20 is transmitted across the network 14. Similar checksum values may be calculated and appended to the IP checksum field 40b, as well as the Ethernet checksum field 40a. Checksum calculations can either be performed in software by the sending entity's central processor unit (“CPU”) or in a hardware circuit designed to calculate checksums. Furthermore, the checksum value in a particular layer is only recognized or otherwise addressed by that layer (i.e., TCP, IP, etc.) independently of the other checksum values embedded or appended to a particular message.

The present invention provides a method for using a checksum field to convey data in order to assess or otherwise measure a particular performance characteristic of a network, for example. By using the checksum field of a particular data packet, additional information usable to assess network performance may be attached to the packet without changing pertinent characteristics or properties of the packet. As such, a measurement packet having modified checksum filed data may be encapsulated having properties nearly identical and/or substantially similar to a payload or message packet, thereby ensuring that the measurement packet is handled the same way as the message packet by the network. Moreover, by substantially duplicating properties of a previously transmitted packet, an application, algorithm, and or protocol may recognize the measurement packet as a substantial duplicate of an earlier packet, and may further recognize the modified checksum value and thus identify the packet as a measurement packet for appropriate processing. Of course, it may not be necessary to duplicate the entire packet, so long as the duplication includes the pertinent packet characteristics affecting the network handling parameters to be measured or otherwise assessed.

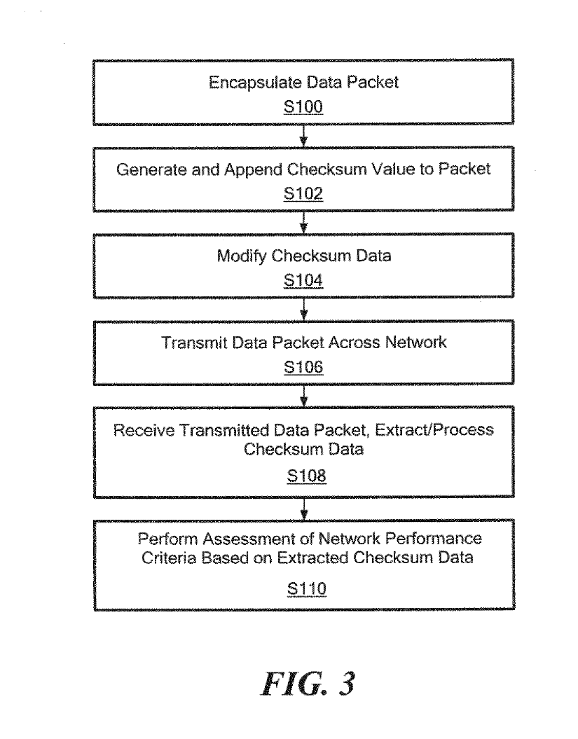

Now referring to the flow chart of FIG. 3, an exemplary method for transmitting data, and more particularly, a method for measuring or otherwise assessing a characteristic of a communication network is shown. Primarily, data to be sent across a communication network is assembled and/or otherwise encapsulated with one or more protocol layers, such as TCP, IP, Ethernet, ATM, X.25 or the like (Step S100). The encapsulated message may include one or more checksum fields in each of the one or more protocol layers, and a checksum may be generated and appended to the message in the appropriate fields for the particular layers (Step S102).

Upon generating and appending or inserting a checksum value to the message, the checksum value in one or more checksum fields of the protocol layers may be altered and/or replaced with a modified value (Step S104). For example, the originally calculated checksum value may be replaced with arbitrary data, and/or may be combined with additional data. The modified data may include, for example, time stamps, encryption keys, a sequence number, identifier, treatment flag, time to live or hops count, expiry time, time before next packet sent, time since last packet sent, etc. The altered checksum value may be further manipulated prior to transmission, such as by an encryption algorithm or the like for security purposes. Furthermore, the particular layer or protocol having the checksum field with the modified value or data may be selected based at least in part on the particular performance criteria or parameter desired to be measured, as well as and/or in the alternative, on how far the modified packet should traverse through the network. For example, a checksum field in a TCP layer may traverse the network and be received/recognized by the ultimate message recipient for measurement of characteristics between the sender and the recipient, while a CRC checksum field in the Ethernet or MAC layer may be read by each node or router, and thus the modified checksum value may cause the packet to be bounced and/or returned to the sending entity for measurement of characteristics between the sender and a first node or router. Accordingly, appropriate layers may be selected for checksum value modification depending on the particular characteristics to be measured.

Of note, the message having the modified checksum value may be substantially similar and/or identical to a previously encapsulated and/or transmitted message, except for the modified checksum value. In other words, the packet having the altered checksum value may otherwise be a duplicate of a previously transmitted message and/or data packet, thereby increasing the likelihood that the packet having the modified checksum value is handled by the network similarly to the previously sent packet. As stated above, by duplicating properties of a message packet, an application, protocol, or system may recognize the duplication and the modified checksum value as an identifying property that the packet is for measurement or performance assessment purposes.

Once the altered checksum value and/or data has been appended or otherwise inserted into the checksum field of the one or more layers, the message may be transmitted across the network, through one or more routers, nodes, or the like, to the message recipient or destination (Step S106). After traversing a particular data path provided by the communication network, the message recipient may receive the message having the altered checksum data for processing and/or extraction of the checksum data (Step S108). The message recipient may recognize that the message having the altered checksum value is a duplicate of a previously sent message, and that the message further includes an invalid or otherwise altered checksum value appended. Such recognition may indicate that the packet is a network measurement or performance metric packet, and the recipient may then extract the checksum value or data and process the packet accordingly. The message recipient may then perform an assessment of one or more network performance parameters based at least upon the data contained in the modified checksum field of the received message (Step S110).

By transmitting data via the checksum field, the remainder of a data packet is left unchanged, which allows the packet having the modified checksum value to traverse the network in the same manner as a payload or data packet having an originally calculated checksum value. This similarity in network treatment enables an increased degree of accuracy and reliability in measuring or otherwise determining a performance aspect of the network, such as delay, dependability, filtering, recognition, etc. as compared to existing methods of sending data and performing similar assessments.

The present invention can be realized in hardware, software, or a combination of hardware and software. An implementation of the method and system of the present invention can be realized in a centralized fashion in one computing system, or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product that comprises all the features enabling the implementation of the methods described herein, and which, when loaded in a computing system is able to carry out these methods. Storage medium refers to any volatile or non-volatile computer readable storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for transmitting a data packet having a checksum field across a network, comprising:
appending a checksum value that does not correspond to the content of the data packet to the checksum field; and
transmitting the data packet.

2. The method according to claim 1, wherein appending the checksum value includes replacement of a checksum value corresponding to content of the data packet with different data.

3. The method according to claim 1, wherein appending the checksum value includes adding additional data to a checksum value corresponding to content of the data packet.

4. The method according to claim 1, wherein the data packet includes one or more protocol headers.

5. The method according to claim 1, wherein the checksum field is in a transmission control protocol header of the data packet.

6. The method according to claim 1, further comprising encrypting the appended checksum value.

7. The method according to claim 1, further comprising:
receiving the data packet; and
extracting the checksum value from the data packet.

8. A method for assessing network performance, comprising:
transmitting a first data packet having a first data in a checksum field across a network;
generating a second data packet, the second data packet being substantially similar to the first data packet, the second data packet having the first data in the checksum field;
changing the first data to a second data in the checksum field;
transmitting the second data packet with the second data across the network; and
assessing a network performance metric based at least in part upon the second data.

9. The method according to claim 8, wherein changing the first data to a second data includes replacement of the first data value with different data.

10. The method according to claim 8, wherein changing the first data to a second data includes adding additional data to the first data.

11. The method according to claim 8, wherein the checksum field is in a transmission control protocol layer of the data packet.

12. The method according to claim 8, further comprising encrypting the modified checksum value.

13. The method according to claim 8, further comprising:
receiving the second data packet; and
extracting the modified checksum value from the second data packet.

14. A system for transmitting data packets across a network, comprising:
a sending entity encapsulating a data packet having at first checksum value in a checksum field, the sending entity modifying the first checksum value to a second checksum value and transmitting the data packet across the network.

15. The system according to claim 14, wherein the first checksum value corresponds to content of the data packet.

16. The system according to claim 15, wherein the second checksum value does not correspond to the content of the data packet.

17. The system according to claim 14, wherein the checksum field is in a transmission control protocol layer of the data packet.

18. The system according to claim 14, further comprising a recipient receiving the data packet and extracting the second checksum value.

19. The system according to claim 18, the recipient assessing a network performance metric based at least upon the second checksum value.

20. The system according to claim 19, wherein the network performance metric includes at least one of a trip time and a network path.
